(19) United States
(12) Patent Application Publication
(10) Pub. No.: US 2025/0038377 A1
(43) Pub. Date: Jan. 30, 2025

(54) BATTERY PACK AND BATTERY SYSTEM

(71) Applicant: TOYOTA JIDOSHA KABUSHIKI KAISHA, Toyota-shi (JP)

(72) Inventors: Keisuke UKITA, Toyoake-shi (JP); Yusuke KURUMA, Toyota-shi (JP); Tsubasa MIGITA, Osaka (JP); Kei MORIKAWA, Toyota-shi (JP); Yasumasa OGUMA, Nagoya-shi (JP)

(73) Assignee: TOYOTA JIDOSHA KABUSHIKI KAISHA, Toyota-shi (JP)

(21) Appl. No.: 18/645,639

(22) Filed: Apr. 25, 2024

(30) Foreign Application Priority Data
Jul. 28, 2023 (JP) 2023-123195

(51) Int. Cl. H01M 50/569; H01M 50/105

(52) U.S. Cl. CPC H01M 50/569; H01M 50/105; H01M 2220/20

(57) ABSTRACT

A cell is a sulfide-based all-solid-state cell. The bus bar of the battery module composed of cells electrically connected in series is connected to the voltage detecting circuit via a printed circuit board including a first conductive trace, a second conductive trace, and a third conductive trace. A portion of the third conductive trace is exposed from the insulating coating film by a cutout portion (missing portion) of the insulating coating film. When the difference between the cell voltage between the first conductive trace and the second conductive trace and the cell voltage between the first conductive trace and the third conductive trace is equal to or larger than a predetermined value, it is determined that the exposed portion of the third conductive trace has been corroded by gas generated from the cell and that gas has been generated from the cell.

### CROSS-REFERENCE TO RELATED APPLICATION

This application claims priority to Japanese Patent Application No. 2023-123195 filed on Jul. 28, 2023, incorporated herein by reference in its entirety.

### BACKGROUND

### 1. Technical Field

The present disclosure relates to battery packs and battery systems.

### 2. Description of Related Art

Japanese Unexamined Patent Application Publication No. 2022-12308 (JP 2022-12308 A) discloses a battery system including a diagnostic device. The battery system includes in a battery pack a gas sensor for detecting the concentration of gas containing hydrogen sulfide. When the concentration detected by the gas sensor is higher than a threshold concentration, the diagnostic device diagnoses that a high concentration abnormality of hydrogen sulfide has occurred.

### SUMMARY

In JP 2022-12308 A, the sensor for detecting the concentration of gas needs to be mounted in the battery pack in order to detect a high concentration abnormality of hydrogen sulfide.

An object of the present disclosure is to allow detection of generation of gas in a battery pack without mounting a sensor for detecting the concentration of gas.

A battery pack according to the present disclosure includes: a cell housed in a battery case and including a first electrode terminal and a second electrode terminal, the cell being a sulfide-based all-solid-state cell; and a printed circuit board including a conductive trace connected to the first electrode terminal and the second electrode terminal. The printed circuit board includes a first conductive trace connected to the first electrode terminal, a second conductive trace and a third conductive trace that are connected to the second electrode terminal, and an insulating coating film covering the first conductive trace, the second conductive trace, and the third conductive trace. At least a portion of the third conductive trace is exposed from the insulating coating film, and is exposed to gas that is generated from the cell.

With this configuration, at least a portion of the third conductive trace is exposed from the insulating coating film, and is exposed to gas that is generated from the cell. Therefore, when gas is generated from the cell, the portion of the third conductive trace that is exposed from the insulating coating film is corroded by the gas. As a result, a change in conductive properties occurs such as an increase in resistance value of the third conductive trace. By detecting this change, it is possible to detect gas generated from the cell without mounting a sensor for detecting the concentration of gas.

The portion of the third conductive trace that is exposed from the insulating coating film may be smaller in thickness than a portion of the third conductive trace that is covered by the insulating coating film.

With this configuration, since the portion exposed from the insulating coating film is thinner than the portion covered by the insulating coating film, the portion exposed from the insulating coating film is more susceptible to corrosion by gas. Therefore, a change in conductive properties of the third conductive trace due to corrosion is large, and it is possible to detect gas generated from the cell.

The cell may include a power generation element that is an all-solid-state cell stack, and an exterior member made of a laminate film, the exterior member containing the power generation element with a peripheral edge portion of the exterior member bonded by heat welding to seal the power generating element in the exterior member. The portion of the third conductive trace that is exposed from the insulating coating film may be disposed adjacent to the second electrode terminal.

With this configuration, the exterior member of the cell is made of a laminate film, and the first electrode terminal and the second electrode terminal extend from the laminate film. Gas (e.g., hydrogen sulfide) generated in the cell tends to leak from a seal portion of the laminate film that sandwiches the first electrode terminal and the second electrode terminal. Since the exposed portion of the third conductive trace that is located adjacent to the second electrode terminal is exposed to gas leaking from the seal portion, a change in conductive properties of the third conductive trace due to corrosion is large, and it is possible to detect gas generated from the cell.

A battery system according to the present disclosure includes: the above battery pack; a detection device connected to the printed circuit board; and a control device. The control device determines that the gas has been generated when the control device detects, using the detection device, that the portion of the third conductive trace that is exposed from the insulating coating film has been corroded.

With this configuration, the control device determines that gas has been generated when the control device detects, using the detection device, that the third conductive trace in the battery pack has been corroded. It is therefore possible to detect gas generated from the cell without mounting a sensor for detecting the concentration of gas.

Preferably, the detection device may be a voltage detecting circuit for the cell, and the control device may determine that the gas has been generated when a difference between a first cell voltage and a second cell voltage is equal to or more than a predetermined value, the first cell voltage being a voltage of the cell detected using the first conductive trace and the second conductive trace, and the second cell voltage being a voltage of the cell detected using the first conductive trace and the third conductive trace.

With this configuration, generation of gas can be detected using the voltage detecting circuit for the cells.

The present disclosure allows detection of generation of gas in the battery pack without mounting a sensor for detecting the concentration of gas.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an overall configuration of a vehicle equipped with a battery pack according to the present embodiment;

FIG. 2A is a schematic configuration diagram of a battery module;

FIG. 2B is a schematic configuration diagram of a battery module;

FIG. 3A is a diagram illustrating a schematic configuration of a cell;

FIG. 3B is a diagram illustrating a schematic configuration of a cell;

FIG. 4 is a diagram for explaining a schematic configuration of a voltage detecting circuit included in a monitoring module; and

FIG. 5 is a diagram illustrating an exemplary flow chart of the gas generation detection process executed by ECU.

### DETAILED DESCRIPTION OF EMBODIMENTS

An embodiment of the present disclosure will be described in detail below with reference to the drawings. Note that the same reference symbols are given to the same or equivalent portions in the drawings, and the description of such portions will not be repeated.

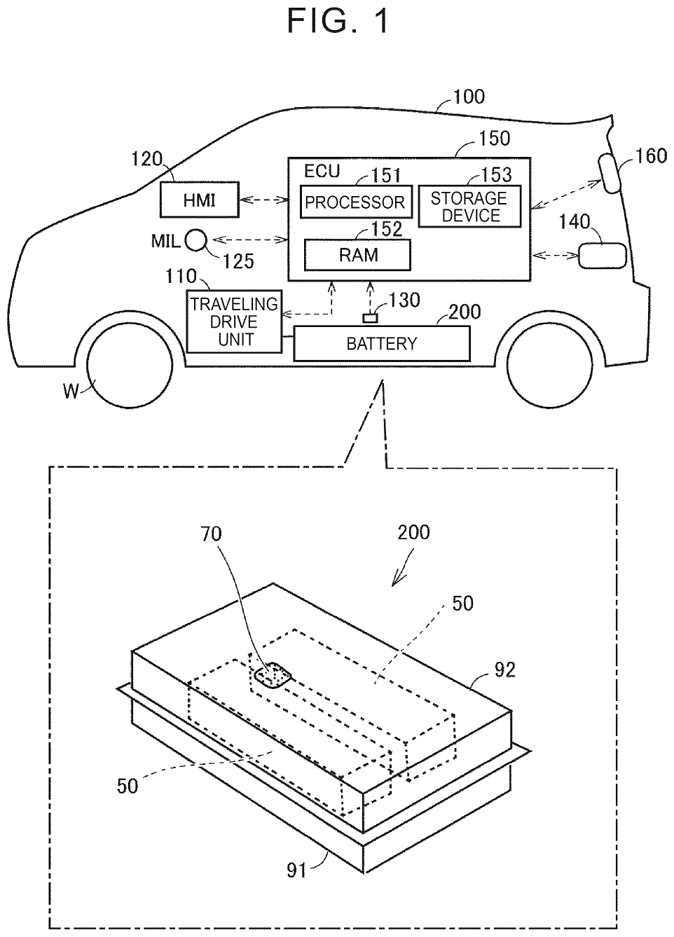

FIG. 1 is a diagram schematically showing an overall configuration of a vehicle 100 equipped with a battery pack 200 according to an embodiment of the present disclosure. The vehicle 100 includes a battery pack 200 that stores electric power for traveling. The vehicle 100 is configured to be able to travel using the electric power stored in the battery pack 200. In the present embodiment, the vehicles 100 are battery electric vehicles (BEV) that do not include engines (internal combustion engines). Vehicle 100 may be an engine-equipped hybrid electric vehicle (HEV) or plug-in hybrid electric vehicle (PHEV).

Vehicle 100 includes a control device (ECU: Electronic Control Unit) 150. ECU 150 is configured to perform charge-control and discharge-control of the battery pack 200. ECU 150 includes a processor 151, a RAM (Random Access Memory) 152, and a storage device 153. RAM 152 functions as working memories for temporarily storing data to be processed by the processor 151. In addition to the program, information (for example, a map, a mathematical expression, and various parameters) used in the program is stored in the storage device 153. The processor 151 executes programs stored in the storage device 153 to perform various types of control in ECU 150.

The monitoring module 130 includes various sensors for detecting the status (e.g., voltage, current, and temperature) of the battery pack 200 (battery module 50), and outputs the detection result to ECU 150. The monitoring module 130 is connected to a printed circuit board 60, which will be described later, and is capable of detecting the voltage of the battery module 50 (cells 10).

The vehicle 100 further includes a traveling drive unit 110, an HMI (Human Machine Interface) device 120, an MIL (Malfunction Indicator Lamp) 125, a hazard lamp 140, an external display device 160, and drive wheels W. The traveling drive unit 110 includes a PCU (Power Control Unit) (not shown) and an MG (Motor Generator) (not shown), and is configured to drive MG by using the electric power stored in the battery pack 200 to cause the vehicles 100 to travel. In addition, MG is configured to perform regenerative power generation and provide the generated electric power to the battery pack 200. The battery pack 200 can be charged (externally charged) by electric power supplied from a charging facility.

HMI device 120 includes an inputting device and a displaying device. HMI device 120 may include a touch panel display. MIL125 is a warning light arranged on the instrument panel. The hazard lamp 140 is a lamp disposed on the front, rear, left, and right sides of the vehicle 100, and is the same lamp as a winker (direction indicator), and functions as an emergency blinking indicator lamp. The external display device 160 is, for example, a LED display device, and is provided in a rear window so that the display content can be visually recognized from the outside of the vehicle 100.

The battery pack 200 includes a battery case 90 and battery modules 50 stored in the battery case 90. The battery case 90 includes a lower case 91 and an upper case 92. In the present embodiment, two battery modules 50 are stored in a space formed by the lower case 91 and the upper case 92. A desulfurization unit (not shown) including a respiratory membrane is attached to the opening 70 of the upper case 92. The inside and the outside of the battery case 90 communicate with each other via a desulfurization unit. When the internal pressure of the battery case 90 increases, the desulfurization unit discharges the air in the battery case 90 to the outside. At this time, the desulfurization unit adsorbs hydrogen sulfide in the air. When the internal pressure of the battery case 90 becomes low, outside air is taken in. The battery pack 200 may be mounted on the floor of the vehicle 100, may be mounted on the inside of the vehicle cabin of the vehicle 100, or may be mounted on the outside of the vehicle cabin of the vehicle 100.

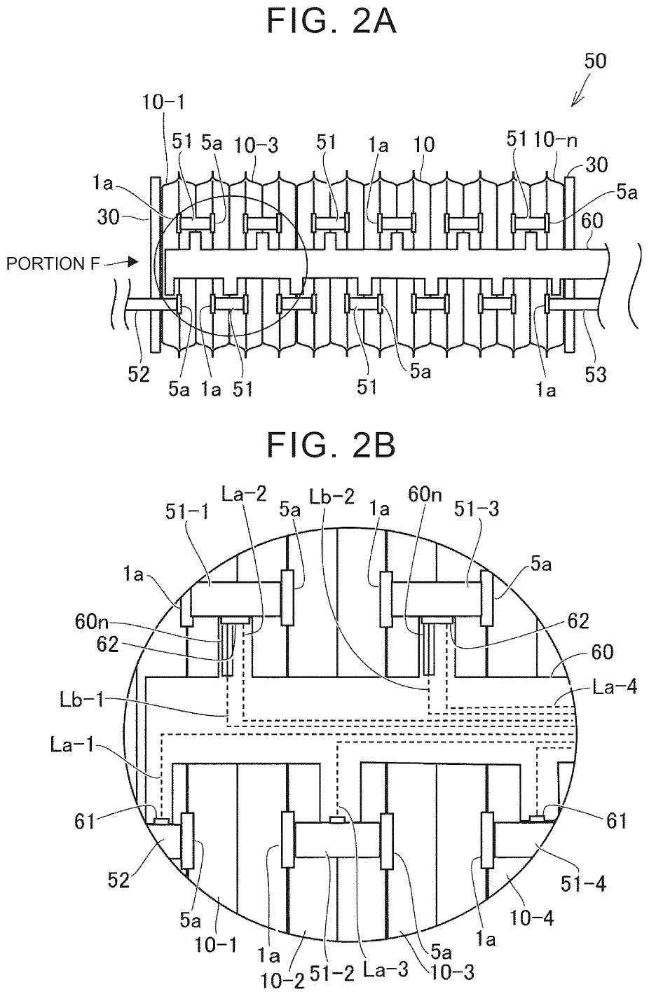

FIGS. 2A and 2B are diagrams illustrating a schematic configuration of the battery module 50. FIG. 2A is a top view of the battery module 50, and FIG. 2B is an enlarged view of the portion F in FIG. 2A. The battery module 50 is a unit composed of a plurality of cells 10 electrically connected in series. The plurality of cells 10 is stacked between the pair of end plates 30.

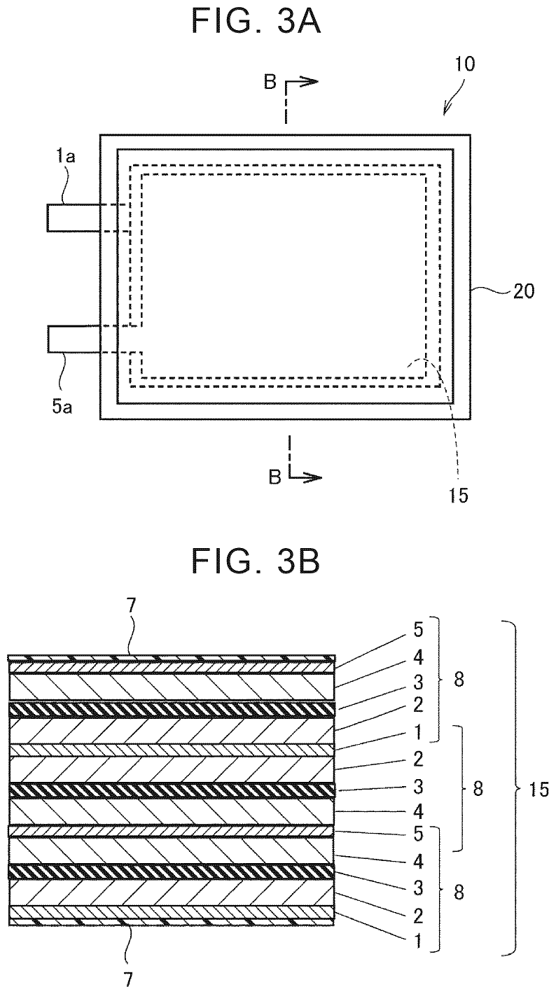

FIGS. 3A and 3B are diagrams illustrating a schematic configuration of a cell 10 according to the present embodiment. FIG. 3A is a top view of a cell 10. The cell 10 is a laminated all-solid-state cell using a laminate film as the exterior member 20, and a negative electrode terminal (negative electrode tab) 1a and a positive electrode terminal (positive electrode tab) 5a extend from the exterior member 20. One of the negative electrode terminal 1a and the positive electrode terminal 5a corresponds to the “first electrode terminal” of the present disclosure, and the other corresponds to the “second electrode terminal” of the present disclosure. The laminate film may be, for example, a pouch made of an aluminum laminate film, and may be a film having a three-layer structure in which an aluminum foil is sandwiched between resin films.

FIG. 3B is an all-solid-state cell stack 15 housed in the exterior member 20, and shows a B-B cross-section of FIG. 3A. The all-solid-state cell stack 15 includes solid-state cell elements 8 each composed of a stack of a negative electrode current collector layer 1, a negative electrode active material layer 2, a solid electrolyte layer 3, a positive electrode active material layer 4, and a positive electrode current collector layer 5 in this order. Three solid-state cell elements 8 are stacked in the reverse direction in the stacking order while sharing the negative electrode current collector layer 1 and the positive electrode current collector layer 5. The negative electrode current collector layer 1 is connected to the negative electrode terminal 1a, and the positive electrode current collector layer 5 is connected to the positive electrode terminal 5a. The number of all-solid-state cell elements 8 included in the all-solid-state cell stack 15 may be one or four or more. The insulating film 7 insulates between the all-solid-state cell stack 15 and the exterior member (laminate film) 20. The all-solid-state cell stack 15 or the all-solid-state cell element 8 corresponds to an example of a “power generation element” of the present disclosure. After the all-solid-state cell stack 15 is housed in the exterior member (laminate film) 20, the outer periphery (peripheral edge portion) of the exterior member 20 is bonded by heat welding (heat fusion) to seal the all-solid-state cell stack 15. As a result, a seal portion is formed in the outer periphery of the exterior member.

The cell 10 is a sulfide-based all-solid-state cell. In the present disclosure, the sulfide-based all-solid-state cell includes a sulfur component in at least one of the material of the positive electrode active material layer 4 and the material of the solid electrolyte layer 3. In the present embodiment, the solid electrolyte layer 3 includes a sulfide-based solid electrolyte, and for example, the sulfide-based solid electrolyte may be made of phosphorus pentasulfide (P₂S₅) and lithium sulfide (Li₂S) as a starting material. In this case, the positive electrode active material layer 4 may include, for example, lithium cobaltate, lithium nickelate, and lithium iron phosphate. When the solid electrolyte layer 3 is composed of an oxide-based solid electrolyte, a sulfur-based positive electrode active material is used as the positive electrode active material layer 4. The sulfur-based positive electrode active material may be an organic sulfur compound or an inorganic sulfur compound. Note that both the solid electrolyte layer 3 and the positive electrode active material layer 4 may contain a sulfur component.

Referring to FIGS. 2A and 2B, a plurality of (n) cells 10 is disposed between a pair of end plates 30 and stacked. The cell 10 is sandwiched between a pair of end plates 30 in a stacked state, and a predetermined restraining load is applied by a restraining band or the like (not shown). In the adjacent cells 10, the negative electrode terminal 1a and the positive electrode terminal 5a are electrically connected in series by the bus bars 51. Although 12 cells 10 are connected in series in FIGS. 2A and 2B, the number of cells 10 may be any number. In FIG. 2A, the bus bar 52 is connected to the positive electrode terminal 5a of the cell 10 located on the leftmost side, and the bus bar 53 is connected to the negative electrode terminal 1a of the cell 10 located on the rightmost side. When two battery modules 50 are connected in series, one of the bus bar 52 and the bus bar 53 is connected to the other battery module 50, and the other is connected to the output terminal. When two battery modules 50 are connected in parallel, the bus bar 52 and the bus bar 53 are connected to the output terminals.

The battery module 50 is provided with a printed circuit board 60 including conductive traces connected to the bus bars 51, 52, and 53. The printed circuit board 60 is, for example, a flexible printed circuit board (FPC: Flexible Printed Circuits). A conductive trace made of a conductive foil (e.g., a copper foil) is provided on the surface of the base film via an adhesive layer. The conductive trace is covered by an insulating coating film (cover layer). As shown in 2B, the printed circuit board 60 is provided with a plurality of conductive traces La and a plurality of conductive traces Lb. The conductive traces La are conductive traces (e.g., copper foil) entirely covered by an insulating coating film, and are shown by dashed lines. The conductive traces Lb are conductive traces partially exposed from the insulating coating film, and the portions of the conductive traces that are exposed from the insulating coating film (hereinafter, also referred to as exposed portions) are shown by solid lines, and the portions of the conductive traces that are covered by the insulating coating film are shown by dashed lines. The exposed portions of the conductive traces Lb may be thinner than the portions of the conductive traces La, Lb that are covered by the insulating coating film. The exposed portion of the conductive trace Lb may be formed by providing a cutout portion 60n in the insulating coating film.

Referring to FIG. 2B, a conductive trace La (La-1) of the printed circuit board 60 is connected to the bus bar 52 via the connector 61. The conductive trace La (La-1) is connected to the positive electrode terminal 5a of the cell 10 (10-1) located on the rightmost side via the bus bar 52. This conductive trace La (La-1) corresponds to the “first conductive trace” of the present disclosure. The bus bar 51 (51-1) connects the negative electrode terminal 1a of the cell 10 (10-1) and the positive electrode terminal 5a of the cell 10 (10-2) adjacent to the cell 10 (10-1). The bus bar 51 (51-1) is connected to the conductive trace La (La-2) and the conductive trace Lb (Lb-1) via the connector 62. The conductive trace La (La-2) and the conductive trace Lb (Lb-1) are connected to the negative electrode terminal 1a of the cell 10 (10-1) and the positive electrode terminal 5a of the cell 10 (10-2) via the bus bars 51 (51-1). The conductive trace La (La-2) corresponds to the “second conductive trace” of the present disclosure, and the conductive trace Lb (Lb-1) corresponds to the “third conductive trace” of the present disclosure.

A conductive trace La (La-3) is connected to the bus bar 51 (51-2) connecting the negative electrode terminal 1a of the cell 10 (10-2) and the positive electrode terminal 5a of the cell 10 (10-3) adjacent to the cell 10 (10-2) via the connector 61. This conductive trace La (La-3) is connected to the negative electrode terminal 1a of the cell 10 (10-2) and the positive electrode terminal 5a of the cell 10 (10-3) via the bus bars 51 (51-2). This conductive trace La (La-3) corresponds to the “first conductive trace” of the present disclosure.

The bus bar 51 (51-3) connects the negative electrode terminal 1a of the cell 10 (10-3) to the positive electrode terminal 5a of the cell 10 (10-4) adjacent to the cell 10 (10-3). The bus bar 51 (51-3) is connected to the conductive trace La (La-4) and the conductive trace Lb (Lb-2) via the connector 62. The conductive trace La (La-4) and the conductive trace Lb (Lb-2) are connected to the negative electrode terminal 1a of the cell 10 (10-3) and the positive electrode terminal 5a of the cell 10 (10-4) via the bus bars 51 (51-3). The conductive trace La (La-4) corresponds to the “second conductive trace” of the present disclosure, and the conductive trace Lb (Lb-2) corresponds to the “third conductive trace” of the present disclosure. Hereinafter, the bus bars 51, 53 are connected to the conductive trace La and the conductive trace Lb, and the printed circuit board 60 is connected to the monitoring module 130 by the same configuration.

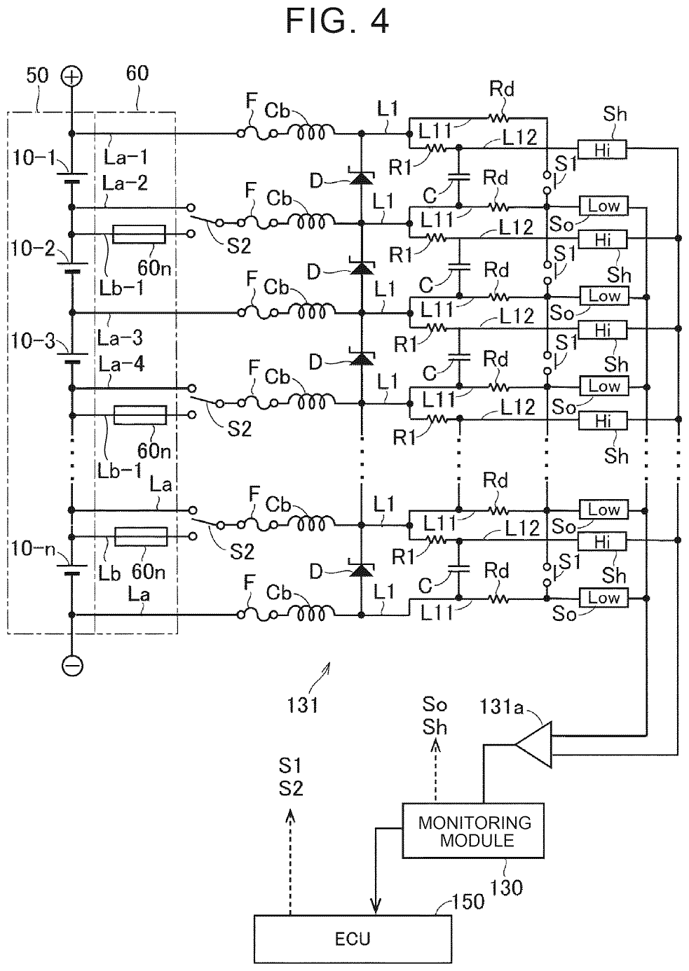

FIG. 4 is a diagram for explaining a schematic configuration of the voltage detecting circuit 131 included in the monitoring module 130. The voltage detecting circuit 131 also has a function of an equalization unit that equalizes the voltages of the cells 10. The monitoring module 130 or the voltage detecting circuit 131 corresponds to an example of a “detection device” of the present disclosure. The voltage detecting circuit 131 is connected to the conductive trace La and the conductive trace Lb of the printed circuit board 60.

The voltage detecting circuit 131 detects the voltage of the cell 10 via the plurality of voltage detection lines L1, the branch lines L11, and the branch lines L12. The voltage detection line L1 is connected to the positive electrode terminal of the cell 10 (10-1) and the negative electrode terminal of the cell 10 (10-n) (more specifically, the bus bars 52 and 53) via the conductive trace La of the printed circuit board 60. Further, the voltage detection line L1 is connected between the cell 10 (10-1) and the cell 10 (10-n) to the negative electrode terminal of one cell and the positive electrode terminal of the other cell (more specifically, the bus bar 51) via the conductive trace La or the conductive trace Lb of the printed circuit board 60.

Between the cell 10 (10-1) and the cell 10 (10-n), a switch S1 is disposed in the bus bars 51 (51-1, 51-3, . . . ) to which the conductive trace La and the conductive trace Lb are connected, and in the voltage detection line L1. The switch S1 selectively switches the connection between the voltage detection line L1 and the conductive trace La and the connection between the voltage detection line L1 and the conductive trace Lb.

A fuse F and a chip-bead Cb are provided in the voltage detection line L1. The fuse F is blown when an overcurrent occurs to protect the circuit. The chip-bead Cb reduces the applied stress when the surge-voltage is applied instantaneously.

A Zener diode D is connected in parallel to the cell 10 via a voltage detection line L1. The cathode of the Zener diode D is connected to the positive terminal side of the corresponding cell, and the anode is connected to the negative terminal side of the corresponding cell. When an overvoltage is applied from the battery module 50 (cell 10) to the voltage detecting circuit 131, a current flows through the Zener diode D to protect the voltage detecting circuit 131 from the overvoltage.

The voltage detection line L1 branches from the Zener diode D to the monitoring module 130 into a branch line L11 and a branch line L12. The branch line L11 is connected to the comparator 131a via the switch So, and the branch line L12 is connected to the comparator 131a via the switch Sh. Switch So and switch Sh may use, for example, photo MOS (Metal Oxide Semiconductor) relays. The branch line L11 branched from the voltage detection line L1 connected to the positive electrode terminal (bus bar 52) of the cell 10 (10-1) disposed on the positive electrode-output terminal of the battery module 50 is not connected to the comparator 131a. In addition, the voltage detection line L1 connected to the negative electrode terminal of the cell 10 (10-n) disposed on the negative electrode output terminal of the battery module 50 does not include the branch line L12.

A resistor R1 is provided in the branch line L12. A capacitor (flying capacitor) C is provided between the branch line L12 connected to the positive electrode terminal of the cells 10 and the branch line L11 connected to the negative electrode terminal. In the branch line L12, the capacitor C is connected between the resistor R1 and the switch Sh, and forms a RC low-pass filter by the resistor R1 and the capacitor C. The capacitor C is connected in parallel with the corresponding cell 10, the charge of the corresponding cell 10 is charged to the capacitor C, and the voltage value of the capacitor C becomes equal to the voltage value of the corresponding cell 10. By turning ON (closing) the switch Sh and the switch So corresponding to the specific cell 10, the comparator 131a outputs the voltage of the specific cell 10. Thus, the monitoring module 130 can detect the voltage of each cell 10 using the voltage detecting circuit 131 by sequentially turning ON the switch Sh and So corresponding to each cell 10.

The voltage detecting circuit 131 includes a discharging resistor Rd provided in the branch line L11 and a switch S1 that conducts (closes) and disconnects (opens) between adjacent branch lines L11, and functions as a equalization unit. For example, by closing the switch S1 corresponding to the cell 10 higher than the reference voltage, the current discharged from the cell 10 is consumed by the discharging resistor Rd, and the voltage of the cell 10 can be made uniform.

In the cell 10, for example, there is a concern that air enters from a sealed part of the exterior member 20 (laminate film). In particular, the negative electrode terminal 1a and the positive electrode terminal 5a (electrode tabs) extend from the seal portion of the exterior member 20. The exterior member (laminate film) 20 is bonded and sealed so as to sandwich the negative electrode terminal 1a and the positive electrode terminal 5a. Air easily enters from the sealed part of the seal portion. When moisture is contained in the entering air, there is a possibility that the sulfur component contained in the solid electrolyte layer 3 or the positive electrode active material layer 4 reacts with moisture to generate hydrogen sulfide, and the hydrogen sulfide is released into the battery case 90. In the present embodiment, generation of hydrogen sulfide is detected by utilizing the fact that the exposed portion of the conductive trace Lb is corroded by hydrogen sulfide and its conductive properties are changed.

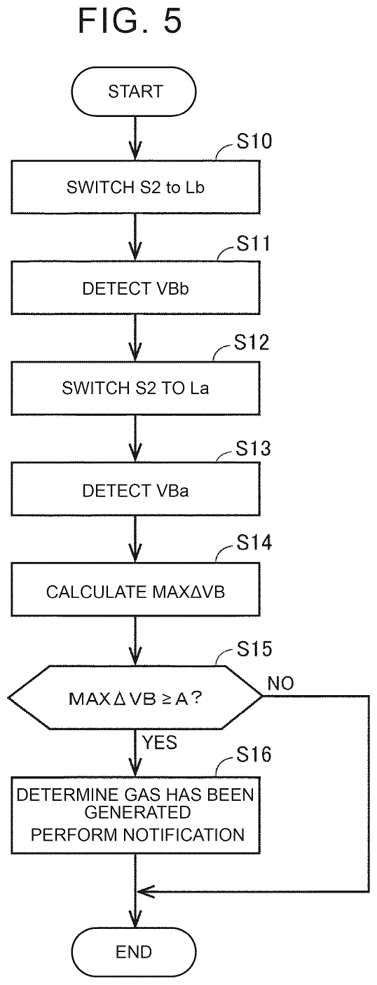

FIG. 5 is a diagram illustrating an exemplary flow chart of the gas generation detection process executed by ECU 150. The flowchart may be processed at predetermined time intervals. For example, when the power switch of the vehicle 100 is ON operated, it may be processed at predetermined time intervals while the vehicle 100 is traveling, and may be processed at the beginning of external charging of the battery pack 200 (battery module 50). In step (hereinafter, step is abbreviated as “S”) 10, the switch S2 of the voltage detecting circuit 131 is switched to the conductive trace Lb. Thus, the conductive trace Lb and the voltage detection line L1 are connected. Subsequently, in S11, after the switch S2 is switched to the conductive trace Lb, the switch Sh and So corresponding to each cell 10 are sequentially turned ON after the set period has elapsed, and the voltage VBb of each cell 10 is detected.

In S12, the switch S2 of the voltage detecting circuit 131 is switched to the conductive trace La. Thus, the conductive trace La and the voltage detection line L1 are connected. Subsequently, in S13, after the switch S2 is switched to the conductive trace La, the switch Sh and So corresponding to each cell 10 are sequentially turned ON after the set period has elapsed, and the voltage VBa of each cell 10 is detected.

In the following S14, the largest value (the largest value) MAXΔVB is calculated in the difference (|VBa−VBb|) between the voltage VBa and the voltage VBb of the individual cells 10, and then the process proceeds to S15. In S15, it is determined whether or not the maximal value MAXΔVB is equal to or greater than the predetermined value A. When the maximum value MAXΔVB is smaller than the predetermined value A (MAXΔVB<A), a negative determination is made, and the present routine is ended.

When the maximum value MAXΔVB is equal to or greater than the predetermined value A (MAXΔVB≥A), an affirmative determination is made and the process proceeds to S16. In S16, it is determined that hydrogen sulfide (gases) is generated from the cell 10. Further, in order to notify the generation of hydrogen sulfide, MIL125 is turned on, the display device of HMI device 120 is displayed to indicate that the battery is abnormal, the hazard lamp 140 is flashed, and the external display device 160 is displayed to indicate that “caution (hydrogen sulfide)”.

When hydrogen sulfide is generated and released in the cell 10, the exposed portion of the conductive trace Lb is corroded by hydrogen sulfide, and its conductive properties change, and the resistance value of the conductive trace Lb increases, for example. Therefore, when the exposed portion of the conductive trace Lb is corroded by hydrogen sulfide, the voltage detection line L1 connected to the conductive trace La and the voltage detection line L1 connected to the conductive trace Lb have a large time-constant difference in RC circuitry including the capacitor C. Therefore, a difference between the voltage VBa detected by using the conductive trace La and the voltage VBb detected by using the conductive trace Lb increases. When the maximum value MAXΔVB is equal to or greater than the predetermined value A, it can be determined that hydrogen sulfide is generated from the cell 10. Generation of hydrogen sulfide can be detected.

When the above-described gas generation detection process is not executed, ECU 150 selects switching of the switch S2 so as to connect the conductive trace La and the voltage detection line L1 at all times. As a result, the voltage detected by using the conductive trace La can be adopted as the voltage of the individual cells 10, and various controls such as battery control can be executed.

According to the above embodiment, the battery module 50 includes cells 10 that are sulfide-based solid-state cells each including a negative electrode terminal 1a and a positive electrode terminal 5a, and a printed circuit board 60 including conductive traces connected to the negative electrode terminals 1a and the positive electrode terminals 5a. The printed circuit board 60 has a conductive trace La connected to one of the negative electrode terminal 1a and the positive electrode terminal 5a, and a conductive trace La and a conductive trace Lb connected to the other of the negative electrode terminal 1a and the positive electrode terminal 5a. The conductive trace La and the conductive trace Lb are covered by an insulating coating film, and a portion of the conductive trace Lb that is adjacent to the negative electrode terminal 1a or the positive electrode terminal 5a is exposed from the insulating coating film. The exposed portion of the conductive trace Lb is exposed to hydrogen sulfide (gases) generated from the cell 10. Therefore, when hydrogen sulfide is generated from the cell 10, the exposed portion of the conductive trace Lb is corroded by hydrogen sulfide. As a result, since the conductive properties of the conductive trace Lb change, hydrogen sulfide generated from the cell 10 can be detected by detecting this change without providing a sensor for detecting the density of the gases. In addition, when the exposed portion of the conductive trace Lb is thinner than the portion covered by the insulating coating film of the conductive trace La and the conductive trace Lb, the exposed portion is more affected by the corrosive effect of hydrogen sulfide. As a result, the change in conductive properties of the exposed portion due to the corrosion becomes large, and the gas generated from the cell 10 is more easily detected.

According to the above embodiment, the cell 10 is a laminated all-solid-state cell whose exterior member 20 is made of a laminate film, and the negative electrode terminal (negative electrode tab) 1a and the positive electrode terminal (positive electrode tab) 5a extend from the exterior member 20. Hydrogen sulfide generated in the cell 10 tends to leak from the seal portion of the exterior member (laminate film) 20 for the negative electrode terminal 1a and the positive electrode terminal 5a. Since the exposed portion of the conductive trace Lb adjoining the negative electrode terminal 1a or the positive electrode terminal 5a is exposed by the gas leaking from the seal portion, the change in conductive properties of the exposed portion due to erosion becomes large, and the gas generated from the cell 10 can be satisfactorily detected.

According to the above embodiment, ECU 150 uses the voltage detecting circuit 131 of the monitoring module 130 connected to the printed circuit board 60 to determine that hydrogen sulfide is generated from the cell 10 when it is detected that the exposed portion of the conductive trace Lb is corroded. Accordingly, hydrogen sulfide generated from the cell 10 can be detected by the voltage detecting circuit 131 of the monitoring module 130 without providing a sensor for detecting the concentration of the gas.

According to the above embodiment, ECU 150 determines that hydrogen sulfide is generated when the difference between the voltage VBa, which is the voltage of the cell 10 detected using the conductive trace La, and the voltage VBb detected using the conductive trace La and the conductive trace Lb is equal to or greater than the predetermined value A. Accordingly, hydrogen sulfide generated from the cell 10 can be detected by using the voltage detecting circuit 131. The voltage detected by the voltage detecting circuit 131 using the conductive trace La is used as the voltage of the individual cells 10. Various controls such as battery control can be executed.

In the above-described embodiment, the voltage VBa and the voltage VBb of the individual cells 10 are detected to detect generation of hydrogen sulfide. The voltages of a plurality of (for example, two to six) cells 10 connected in series may be detected in the same manner as in the above-described embodiment, and the generation of hydrogen sulfide may be detected. In addition, the voltage of the battery module 50 (the voltage between the bus bar 52 and the bus bar 53) and the generation of hydrogen sulfide may be detected in the same manner as in the above-described embodiment.

In the above-described embodiment, the voltage of the cell 10 is detected by using the capacitor (flying capacitor) C in the voltage detecting circuit 131, but the voltage of the cell 10 may be detected without using the capacitor C. In this case, since the exposed portion of the conductive trace Lb is corroded, for example, the resistance value is increased, so that a voltage difference corresponding to the resistance value can be detected. Further, two voltage detecting circuits may be provided without providing a switch S2, and the voltage VBa of the cell 10 and the voltage VBb of the cell 10 may be detected by each voltage detecting circuit.

In the above embodiment, an example in which the battery pack 200 (battery module 50) is mounted on the vehicle 100 has been described. The battery pack 200 may be a stationary energy storage device.

The embodiment disclosed this time should be considered to be illustrative in all respects and not restrictive. The scope of the present disclosure is indicated by the claims rather than the description of the embodiment described above, and it is intended that all changes within the meaning and scope equivalent to the claims are included.

What is claimed is:

1. A battery pack comprising:
a cell housed in a battery case and including a first electrode terminal and a second electrode terminal, the cell being a sulfide-based all-solid-state cell; and
a printed circuit board including a conductive trace connected to the first electrode terminal and the second electrode terminal, wherein:
the printed circuit board includes
a first conductive trace connected to the first electrode terminal,
a second conductive trace and a third conductive trace that are connected to the second electrode terminal, and
an insulating coating film covering the first conductive trace, the second conductive trace, and the third conductive trace; and
at least a portion of the third conductive trace is exposed from the insulating coating film, and is exposed to gas that is generated from the cell.

2. The battery pack according to claim 1, wherein the portion of the third conductive trace that is exposed from the insulating coating film is smaller in thickness than a portion of the third conductive trace that is covered by the insulating coating film.

3. The battery pack according to claim 1, wherein:
the cell includes
a power generation element that is an all-solid-state cell stack, and
an exterior member made of a laminate film, the exterior member containing the power generation element with a peripheral edge portion of the exterior member bonded by heat welding to seal the power generating element in the exterior member; and
the portion of the third conductive trace that is exposed from the insulating coating film is disposed adjacent to the second electrode terminal.

4. A battery system comprising:
the battery pack according to claim 1;
a detection device connected to the printed circuit board; and
a control device, wherein the control device determines that the gas has been generated when the control device detects, using the detection device, that the portion of the third conductive trace that is exposed from the insulating coating film has been corroded.

5. The battery system according to claim 4, wherein:
the detection device is a voltage detecting circuit for the cell; and
the control device determines that the gas has been generated when a difference between a first cell voltage and a second cell voltage is equal to or more than a predetermined value, the first cell voltage being a voltage of the cell detected using the first conductive trace and the second conductive trace, and the second cell voltage being a voltage of the cell detected using the first conductive trace and the third conductive trace.
